(19) United States
(12) Patent Application Publication
(10) Pub. No.: US 2007/0091369 A1
(43) Pub. Date: Apr. 26, 2007

(54) Printer and printing method

(76) Inventors: Hsue-Yang Liu, Vancouver, WA (US); Michael V. Conca, Vancouver, WA (US); Tom B. Pritchard, Brush Prairie, WA (US); Thieu X. Dang, Camas, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/256,579

(22) Filed: Oct. 21, 2005

(51) Int. Cl. G06F 3/12

(52) U.S. Cl. 358/1.18; 358/1.1; 358/3.06

(57) ABSTRACT

A printer comprises a print engine and a print head. The print engine separates combined image/dot pattern data into image data and dot pattern data. The print engine separately processes the image data and the dot pattern data and merges the separately-processed image data and dot pattern into print data for printing. A print head prints the print data.

### BACKGROUND OF THE DISCLOSURE

In digital pen and paper (DPP) technology, an optical sensor detects a pattern of reference dots on the surface of a printed medium. The pattern of dots includes dots of given sizes, shapes and locations with a given offset from known reference positions across the surface of the medium. An optical sensor tracks the position of a writing instrument or other input device as it passes over the medium by detecting and recognizing the dots, their position, size, shape and offset from know reference positions. Accurate printing of the dots may enhance the performance of the system by creating dots more closely representative of the nominal, expected size, shape, location and offset position.

The printed medium may also be pre-printed with an image, for example text, graphics and/or a form to be filled out by a user. In the case of a form, for example, a user can fill in the form by hand using a pen, pencil or other input device. The optical sensor and DPP software detect the manual input and fill in a corresponding digital copy of the form stored in memory.

A DPP driver may process the image to be printed in a resolution that is less than the resolution with which the printer may print. For example, the DPP driver may process an image at a 600×600 dpi resolution whereas the printer may print at 1200×1200 dpi resolution. As a result, the size, shape and positioning sensitivity and accuracy of the dot data generated by the DPP driver may not take full advantage of the resolution capabilities of the printer.

In ink-jet printing, the surface characteristics of a medium may affect the size of dots to be printed. For example, ink may diffuse into fibers on the paper and migrate away from the nominal positions where the emitted ink droplet was aimed and landed. As a result, the size, shape and location of a dot printed on the paper may be different from, for example larger than, the nominal, expected dot printed in accordance with the print data provided from a print data source.

### BRIEF DESCRIPTION OF THE DRAWINGS

Features and advantages of the disclosure will be readily appreciated by persons skilled in the art from the following detailed description of exemplary embodiments thereof, as illustrated in the accompanying drawings, in which:

FIG. 1 illustrates an exemplary embodiment of a method of printing.

FIG. 2 illustrates an exemplary embodiment of a printing system.

FIG. 3 illustrates an exemplary embodiment of dot pattern data.

FIG. 4 illustrates an exemplary embodiment of dot pattern data.

FIGS. 5A-5D illustrate exemplary embodiments of depleted dot pattern data.

### SUMMARY OF THE DISCLOSURE

A printer comprises a print engine and a print head. The print engine separates combined image/dot pattern data into image data and dot pattern data. The print engine separately processes the image data and the dot pattern data and merges the separately-processed image data and dot pattern into print data for printing. A print head prints the print data.

### DETAILED DESCRIPTION OF THE DISCLOSURE

In the following detailed description and in the several figures of the drawing, like elements are identified with like reference numerals.

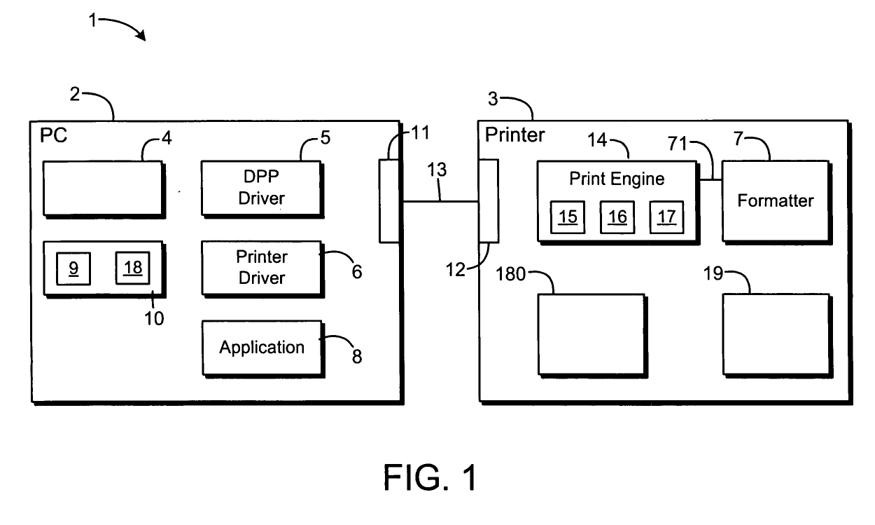

FIG. 1 illustrates an exemplary embodiment of a print system 1. In an exemplary embodiment, the print system may include a computer 2, for example a PC, and a printer 3. The computer 2 may include a processor 4, for example a CPU, a DPP driver 5, printer driver 6, and an application 8. In an exemplary embodiment, the printer may have image data 9 stored in memory.

In an exemplary embodiment, the DPP driver 5 may include software on the computer CPU or processor 4. In an exemplary embodiment, the DPP driver 5 may generate a dot pattern 18 for use in DPP printing. The dot pattern 18 may be stored in memory 10. In an exemplary embodiment, the dot pattern 18 may be a dot pattern suitable for use as a reference pattern to be printed on a print medium for use in DPP technology. For example, the dot pattern data 18 may represent dots of particular sizes and/or shapes to be printed in particular locations—or with particular position offsets with respect to particular reference positions.

In an exemplary embodiment, the printer driver 6 may a piece of software that resides between the application 6 and the operating system. In an exemplary embodiment, the application 8 may be a word processing program, spreadsheet program, drawing program or other program or application which may provide image data 9 to be merged with a dot pattern 18 for printing for use in a DPP system. In an exemplary embodiment, the Application 8 may send high level commands to the printer driver 6 to print one or many pages. The printer driver 6 may convert the high level commands into specific printer commands. In an exemplary embodiment, the printer driver 6 may merge the image data 9 with the dot pattern 18 to be communicated to the printer 3 for printing.

In an exemplary embodiment, the printer driver 6 and the application 8 may generate printer-specific commands to be transferred from the computer 2 to the printer 3 along with dot pattern 18 data and image data 9 to be printed by the printer 3. In an exemplary embodiment, the printer-specific commands may be based on the media onto which the image is to be printed, size of the image, and a print quality selected by a user.

In an exemplary embodiment, the image data 9 may include graphic image data, form data and/or text data which may be provided, for example, by the application 8. In an exemplary embodiment, the image data 9 may be for use in DPP technology and may comprise data representative of a form to be printed on a print medium. The DPP technology may use an optical sensor to digitally capture information manually input onto the form using a DPP pen, pencil or other input device.

In an exemplary embodiment, the computer 2 may include a communications port 11 which communicates with a communications port 12 by a connection 13. In an exemplary embodiment, the connection may by cable or wireless. In an exemplary embodiment, the connection may be by a wire protocol including, for example, Centronics-1284 (parallel), USB, and Ethernet. In an exemplary embodiment, the computer 2 may transfer image data 9, dot pattern 18 data and printer-specific commands from the communications port 11 of the computer 2 to the communications port 12 of the printer 3.

In an exemplary embodiment, the printer 3 may include a formatter 7. In an exemplary embodiment, the formatter 7 may include a CPU, software, firmware ASICS or a combination of software, firmware and/or ASICS. In an exemplary embodiment, the formatter may convert received data into print engine-specific commands for printing by the printer 3. In an exemplary embodiment, the formatter 7 converts the data in accordance with printer-specific commands from the print driver and/or application.

In an exemplary embodiment, the printer 3 may include a print engine 14 for processing data from the computer 2 for printing. In an exemplary embodiment, the print engine 14 may include a controller 15, for example a CPU, ASICS 16, software 17 and/or other hardware used in processing data for printing. In an exemplary embodiment, the formatter 7 may communicate with the print engine 14 through a communications interface 71, for example a PCI bus.

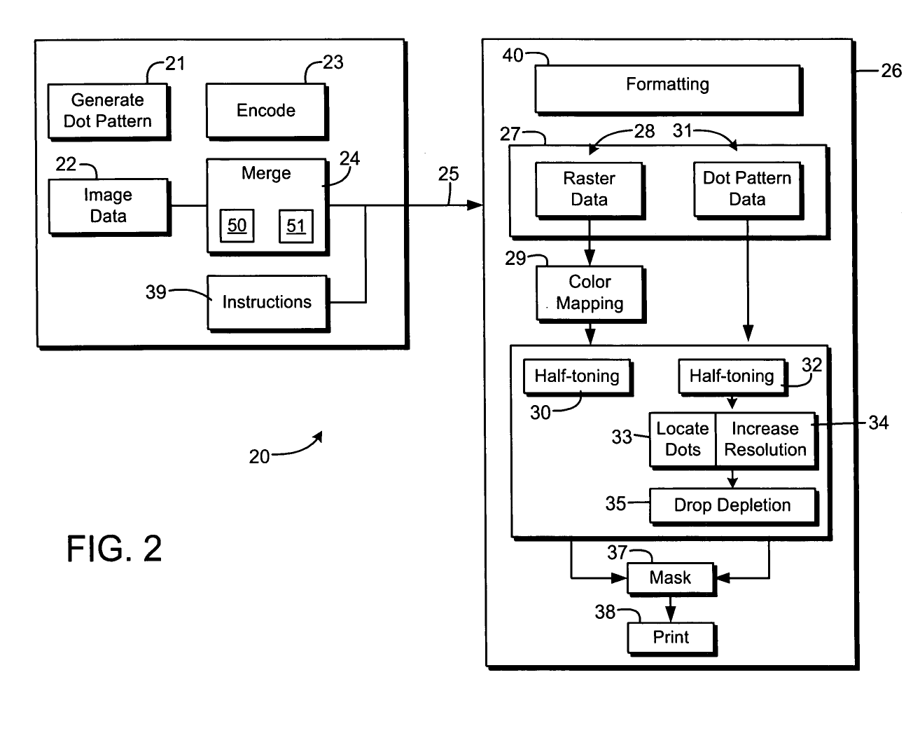

In an exemplary embodiment, the printer 3 may include a printhead 180 and a supply 19 of ink, colorant or toner. In an exemplary embodiment, the printhead may be an inkjet, for example a thermal inkjet, printhead. In an exemplary embodiment, the print engine 14 may control the printhead 180 to emit ink according to data to form an image. In an exemplary embodiment, the print system 1 may be operated in accordance with a print method as described below with respect to FIG. 2.

FIG. 2 illustrates an exemplary embodiment of a method 20 of print data processing for DPP printing. In an exemplary embodiment, the method may include generating 21 dot pattern data 18 (FIG. 1) and providing 22 image data 9 (FIG. 1). In an exemplary embodiment, the dot pattern data may be generated by a DPP driver 5 (FIG. 1).

In an exemplary embodiment, the dot pattern data may be encoded 23 with a color value. The color value may be a unique color value in that the color value or values is a value or values which are not to be assigned to any portion of image data with which the dot pattern data may be merged. In this way, in a subsequent processing step which may occur in a print engine of a printer as explained further below, the dot pattern data may be recognized and separated from the remaining image data for separate image processing in the print engine. In an exemplary embodiment, the unique color variable may be, for example, an 8-bit RGB color value or other format including, for example, 2-bit KCMY, 24-bit CMY, 32-bit KCMY. In an exemplary embodiment, the dot pattern data may be assigned the 8-bit RGB color value of 0, 0, 1 (R=0, G=0, B=1).

In an exemplary embodiment, the providing 22 the image data may comprise providing data which includes some form of color information, for example 8-bit RGB color values. In an exemplary embodiment, providing 22 the image data may include avoiding using the unique color code used for the dot pattern data to any portion of the image data. For example, if the unique dot pattern color code is 0, 0, 1, then no portion of the image data will be assigned the color 0, 0, 1.

In an exemplary embodiment, the print data processing method 20 may include merging 24 the dot pattern data and the image data into one document. In an exemplary embodiment, the document may be an 8-bit RGB document. In an exemplary embodiment, the only portion of the merged image data that may be encoded with the unique color code may be those portions of the merged data that correspond to dots of the dot pattern to be printed on the print medium. In an exemplary embodiment, merging 24 the data may include filtering out 50 the unique color value or values from the image data. In an exemplary embodiment, merging 24 the data may include replacing 51 any portions of the image data which were represented by the unique color code by reassigning those portions with a color value nearby or adjacent to the unique color variable as an approximation in the particular color scheme. For example, if the unique color code is RGB=(0, 0, 1), then all the pixels in the image where RGB value is (0, 0, 1) may be modified to have values of (1, 0, 0) or (0, 1, 0). In an exemplary embodiment, the merging may be performed by the printer driver.

In an exemplary embodiment, the method 20 may include providing 39 printer-specific instructions for printing of the image data and dot pattern. In an exemplary embodiment, the print driver and/or the application may provide 39 printer specific instructions. In an exemplary embodiment, the printer-specific instructions may relate, for example, to the print medium or media, size of the image, number of prints, one- or two-sided prints and/or print quality selected by a user.

In an exemplary embodiment, the merged data may be transferred 25 to a print engine, for example by a wire protocol which may include, for example, Centronics-1284 (parallel), USB, and Ethernet. In an exemplary embodiment, the printer-specific commands may also be transferred 25 to the print engine. In an exemplary embodiment, the merged data and/or the printer-specific commands may be received by a print engine.

In an exemplary embodiment, the method may include image processing 26 of the merged document performed, for example, by the formatter 7 and/or the print engine 14 (FIG. 1). In an exemplary embodiment, the processing 26 may occur as the data is received. Some data may be stored in memory temporarily during processing.

In an exemplary embodiment, the formatter may receive the printer-specific commands and convert 40 them into print data to be processed. In an exemplary embodiment, the Formatter may, for example, render the text into raster. In an exemplary embodiment, a formatter, for example a formatter for a multi-function printer, may also control the scanners and all image pipeline for copy path.

In an exemplary embodiment, the print engine and/or image processor may separate 27 the dot pattern from the raster data for the image data for processing in separate channels. In an exemplary embodiment, the dot data/image data separation 27 may be performed by the print engine.

In an exemplary embodiment, the image processor separates 27 the image data raster data from the dot pattern data by identifying those portions of the merged image which are encoded with the unique color value. In an exemplary embodiment, the raster data are processed separately from the dot pattern data. In an exemplary embodiment, separate processing may enable the selective drop depletion of drops to be emitted to form the dots as described below.

In an exemplary embodiment, the method may include processing 28 the raster data for the image data in one channel. In an exemplary embodiment, processing the image data may include color mapping 29 the raster data and halftoning 30 the color-mapped raster data.

In an exemplary embodiment, the method may include separating 31 the dot pattern data for processing in a separate channel from the image data. In an exemplary embodiment, the method may include halftoning 32 of the dot pattern data. In an exemplary embodiment, halftoning 32 the dot pattern data may include reducing the bit depth of the dot pattern data. For example, halftoning may reduce an 8-bit color code to low-bit on or off.

In an exemplary embodiment, the halftoning 32 may be performed line-by-line on the dot pattern data. In an exemplary embodiment, the method may include searching the half-toned dot pattern data to locate 33 the position of the dots to be printed. In an exemplary embodiment, the method may include increasing the resolution 34 of the dot pattern data from its original resolution, as used in the computer for processing the image to be printed, to a higher resolution, where the print engine has the capability of printing at a higher resolution than the computer, or where it may be more efficient to process images at lower resolution on an application on the computer, yet print them at higher resolution through the print engine on the printer.

For example, if in an exemplary embodiment the dot pattern data as represented in 600×600 dpi resolution would have resulted in a 2×2 pattern of dots in 600×600 dpi printing, the dot pattern may be expanded to a 4×4 pattern of dots to be printed by the printer. In an exemplary embodiment, the method may include selectively depleting 35 drops to be emitted from the dot pattern data as explained below.

In an exemplary embodiment, the method 20 may include merging 24 the processed image data back with the processed dot pattern data for printing. In an exemplary embodiment, merging may occur while being processed in an ASIC. In an exemplary embodiment, the color value data may create separate planes of data. For example, when RGB data is used, there may be four separate planes of data—K, C, M and Y. The K data may contain the merged black data from the image and the DPP dot pattern data. In an exemplary embodiment, the K plane pixels may be encoded with more than one bit.

In an exemplary embodiment, a shingle mask may be applied 37 to determine the operation of the printhead during printing of the image and then printing 38 the dots by emitting droplets of colorant or ink corresponding to the merged image data and dot pattern data.

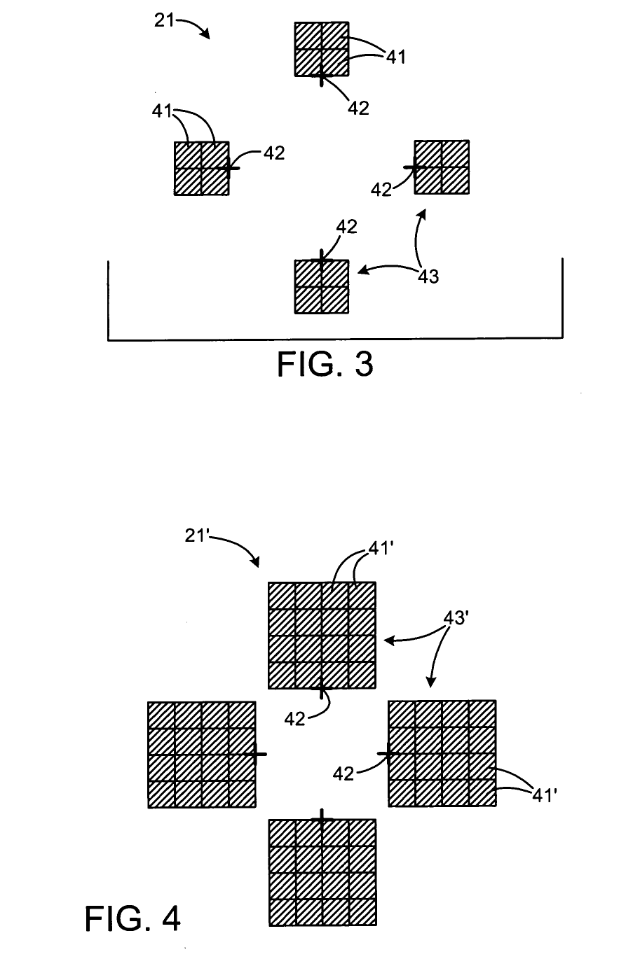

FIG. 3 graphically illustrates an exemplary embodiment of drop data 21 provided by a DPP driver. In an exemplary embodiment, the DPP driver creates dot pattern data 21 for 600×600 dpi printing. In an exemplary embodiment, the dot pattern data 21 may include a plurality of dots 43 to be printed. In an exemplary embodiment, the dot pattern data 21 may provide that each dot 43 is to be printed using a 2×2 pattern of pixels 41 (which if printed in 600×600 dpi may be representative of a 2×2 pattern of emitted drops to form the dot on a medium). In an exemplary embodiment, the dot data 21 may assign the dots to particular reference positions 42 on the medium to be printed, or may show the dots offset from particular reference positions 42. In the exemplary embodiment of FIG. 3, reference positions are shown with a cross-and the drop data patterns are shown offset from various reference positions 42 above, below, to the right or left of the reference positions. In the exemplary embodiment of FIG. 3, the drop data for pixel drops to be emitted are represented by squares with a nominal size and relative position with respect to the other drops to be emitted and nominal position relative to the reference position 42.

FIG. 4 illustrates an exemplary embodiment of a graphic representation of the dot pattern data 40′ of FIG. 3 after increasing the resolution 34 (FIG. 2) for printing on a higher resolution printer, for example a 1200×1200 dpi printer. In an exemplary embodiment, the dot patterns 21′ correspond to the dot patterns 21 of FIG. 3. As in FIG. 3, the crosses designate reference positions 42 and the individual squares indicate pixels 41′ to be printed. In an exemplary embodiment, the dots are offset from the reference positions 42 above, below, to the right and to the left from the reference positions. In an exemplary embodiment, the 2×2 600×600 dpi pixel patterns of FIG. 2 have been expanded to 4×4 1200×1200 dpi pixel patterns which when printed in 1200×1200 dpi may be printed by a 4×4 pattern of emitted drops.

In an exemplary embodiment, interactions among the surface of a print medium, the ink and the flight characteristics of emitted drops to be printed may affect the size, shape, location and accuracy of dots printed with emitted drops. For example, if the ink diffuses or migrates across the surface of the print medium—away from the nominal, expected position on the medium, the size, position and shape of the drop may be less easily recognized by the DPP optical sensor and DPP software.

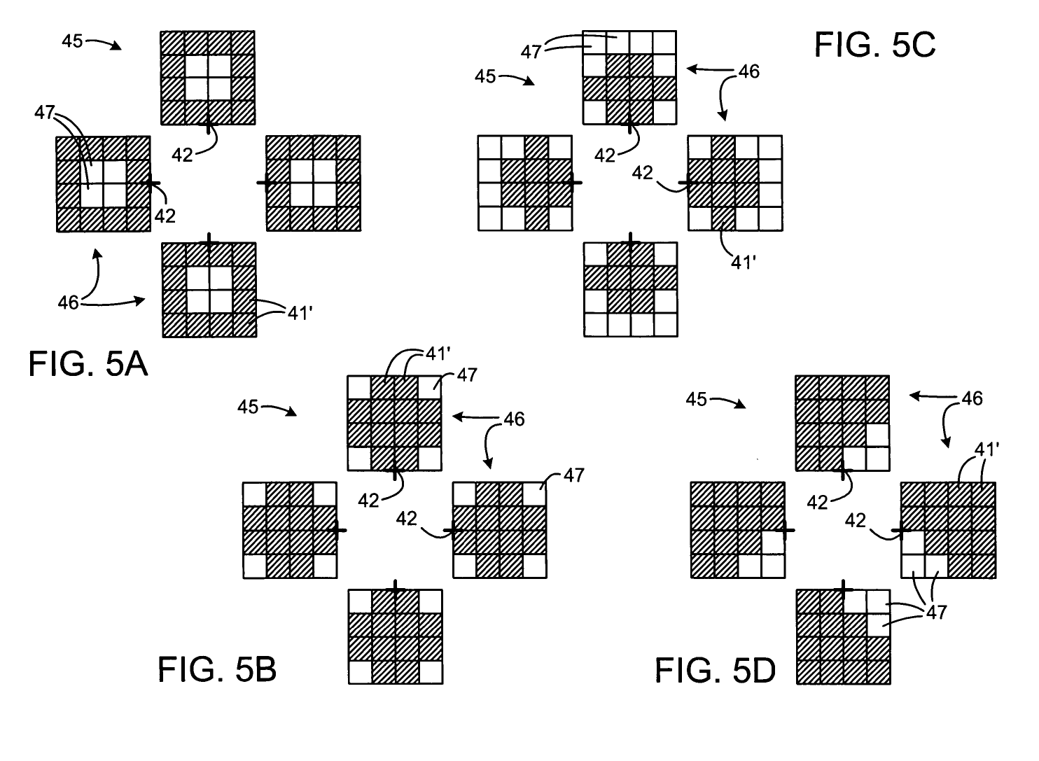

In an exemplary embodiment, selectively depleting 35 (FIG. 2) the dot patterns 21′ may include changing dot pattern data so that some of the pixels in a dot pattern are turned off. In an exemplary embodiment, depleting a dot pattern may result in a dot formed by fewer emitted drops. In an exemplary embodiment, depleting a dot pattern may reduce or mitigate inaccuracies caused by ink diffusion or migration after printing and may provide higher resolution dot placement, size and shape control. FIGS. 5A-5D illustrate various embodiments of selectively depleted dot patterns.

FIG. 5A illustrates exemplary depleted dot pattern data 45. The depleted dot pattern data 45 may include depleted dot patterns 46 in which the center four pixels 47 have been depleted from the original dot pattern 43′ (FIG. 4). In an exemplary embodiment, the pixels 41′ at the outside of the depleted dot 46 may diffuse or migrate inward, toward those portions of the pattern onto which no ink was emitted. This inward diffusion or migration may fill in the printed dot and may reduce the tendency of ink to diffuse outward from the dot. In an exemplary embodiment, this may form a printed dot that is closer to nominal, expected size for use in the DPP system.

FIG. 5B illustrates dot pattern data 45 in which the outside corners of a 4×4 depleted dot pattern 46 have been depleted. In an exemplary embodiment, the lower volume of ink emitted onto the surface may prevent the size of the dot from expanding to a larger size as far as it might if all of the 16 positions had drops emitted onto them. The empty squares represent depleted pixels 47.

FIG. 5C illustrates a dot pattern in which a row or column of drops furthest away from the reference point are depleted—and in which the corner drops of the remaining 3×4 or 4×3 pattern are also depleted. The empty squares represented the depleted pixels 47. In an exemplary embodiment, this may create dot patterns in which the center of the dots are closer to the reference patterns than the center of a 4×4 pattern would have been. In an exemplary embodiment, such a pattern may be capable of meeting an offset distance tolerance that would have been more difficult to achieve through the lower resolution processing at the DPP driver. In an exemplary embodiment, the closer tolerances may enable more precise and/or accurate DPP recognition by the optical sensor and DPP software.

FIG. 5D illustrates an exemplary embodiment of a selectively depleted dot pattern 45 in which three pixels 47 at a corner of the 4×4 dot patterns have been depleted from the dot patterns 46. In an exemplary embodiment, such a depleted pattern 46 may create smaller dots and may create dots with a center which may be placed with more fine resolution at smaller distances of offset from reference positions.

In an exemplary embodiment, a depleted drop depletion pattern 45 for a given application may depend on characteristics of the print engine, the print head, the ink, the print medium and the DPP driver dot size, position and offset requirements. In an exemplary embodiment, an optimal, preferred or nominally preferable drop depletion pattern for dot patterns may be developed during product development of a particular printer, print system, printhead and for use with specific inks or colorants in combination with the printer, print system or printhead and taking into account the characteristics of a particular print medium or paper to be used with the print system. In an exemplary embodiment, a drop depletion pattern for a particular printhead/print medium combination or combinations may be developed by testing a number of exemplary drop depletion patterns and measuring the dot offset.

In an exemplary embodiment, a method for controlling dot shape, size and location may include emitting droplets of an invisible fixer. In an exemplary embodiment, the invisible fixer may comprise a fixer or fixing fluid. A fixer or fixing fluid may comprise a components that may react or “fix” a colorant in the ink. A fixer may be colorless. In an exemplary embodiment, a fixer may comprise a solvent, surfactant, pH stabilizer, and/or biocide. In an exemplary embodiment, the invisible fixer may be designed to interact with the ink and surface of a print medium to mitigate or limit the surface effects of ink on the surface of the medium. For example, emitting droplets of invisible fixer onto pixel positions on a print medium onto which droplets of ink are to be emitted may limit the diffusion or migration away from the nominal position of the pixel position. The addition of fixer may provide another control for dot shape. In an exemplary embodiment, using a combination of fixer and depleted dot pattern may provide for selectively adjusting the dot shape and size for different print engines and print media. In an exemplary embodiment, a print system or printer may be able to support more than one print media and ink combination.

It is understood that the above-described embodiments are merely illustrative of the possible specific embodiments which may represent principles of the present invention. Other arrangements may readily be devised in accordance with these principles by those skilled in the art without departing from the scope and spirit of the invention.

What is claimed is:

1. A method of printing, comprising:
providing data to a print engine, wherein the data comprises dot pattern data merged with image data, wherein the dot pattern is encoded with a unique color variable and the image data is not encoded with the unique color variable;
separating the image data from the dot pattern data;
processing the image data separately from the dot pattern data to generate processed image data;
processing the dot pattern data separately from the image data, wherein processing the dot pattern data comprises depleting the dot pattern data to generate depleted dot pattern data;
merging the depleted dot pattern data with the processed image data to generate print data; and
printing the image data in accordance with the print data.

2. The method according to claim 1, wherein the dot pattern data comprises dot pattern data for digital pen and paper (DPP).

3. The method according to claim 1, wherein processing the dot pattern data comprises reducing the bit depth of the unique color variable.

4. The method according to claim 1, wherein the dot pattern has a resolution and processing the dot pattern data comprises increasing the resolution of the dot pattern data.

5. The method according to claim 4, wherein the dot pattern has a resolution of 600×600 dpi and increasing the resolution of the dot pattern data comprises increasing the resolution to 1200×1200 dpi.

6. The method according to claim 1, wherein processing the image data comprises processing raster data.

7. The method according to claim 1, wherein processing the image data comprises at least one of color mapping and/or halftoning.

8. The method according to claim 1, further comprising:
generating dot pattern data;
encoding the dot pattern data with a unique color variable;
providing image data, wherein providing image date comprises providing image data which is not encoded with the unique color variable; and
merging the encoded dot pattern data with the image data to create the data.

9. The method according to claim 8, wherein providing image data which is not encoded with the unique color variable comprises filtering the image to remove portions of the image data represented by the unique color variable and replacing the portions of the image data with a color variable nearby or adjacent to the unique color variable.

10. A printer comprising:
a print engine, wherein the print engine separates combined image/dot pattern data into image data and dot pattern data, separately processes the image data and the dot pattern data, and merges the separately-processed image data and dot pattern into print data for printing; and
a print head, wherein the print head prints the print data.

11. The printer according to claim 10, wherein the combined image/dot pattern data includes dot pattern data encoded with a unique color variable and wherein the combined image/dot pattern data includes image data which does not include the unique color variable.

12. The printer according to claim 10, wherein the print engine halftones the dot pattern data and selectively depletes the dot pattern.

13. The printer according to claim 10, wherein the print engine halftones the dot pattern data, increases the resolution of the dot pattern data and selectively depletes the dot pattern data.

14. A computer comprising:
a digital pen and paper (DPP) driver, wherein the DPP driver provides a dot pattern and encodes the dot pattern with a unique color variable;
an application, wherein the application provides image data;
a printer driver, wherein the printer driver filters the image data to remove the unique color variable from the image data and combines the dot pattern and the image data for transfer to a printer for printing.

15. The computer according to claim 14, wherein the image data comprises data representative of a form to be filled out and the dot pattern comprises a reference pattern for use in digital pen and paper technology.
